(19) United States
(12) Patent Application Publication
(10) Pub. No.: US 2005/0148231 A1
(43) Pub. Date: Jul. 7, 2005

(54) Plug guide

(75) Inventors: Thomas Riester, Villingen-Schwenningen (DE); Torsten Wahler, Bar Duerrheim (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/035,144

(22) Filed: Jan. 13, 2005

Related U.S. Application Data
(63) Continuation of application No. PCT/DE03/02037, filed on Jun. 18, 2003.

(30) Foreign Application Priority Data
Jul. 23, 2002 (DE) 10233441.2

(51) Int. Cl. H01R 13/64

(52) U.S. Cl. 439/377

(57) ABSTRACT

The invention relates to a plug guide for connecting a plug on a first circuit board to a mating connector, or a plug receiving element, on a second circuit board. The first circuit board is used for a display of a digital tachograph and the second circuit board is a system circuit board inside a housing for the digital tachograph. According to the invention, the plug on the first circuit board is provided with a plug guide in order to prevent the risk of mis-insertion during the insertion thereof, which cannot be visually monitored. Said plug guide essentially surrounds the plug in a u-shaped manner and is secured in relation to the plug.

### CROSS REFERENCE TO RELATED APPLICATIONS

The present application is a continuation of international application PCT/DE2003/002037, filed Jun. 18, 2003, which designated the United States and further claims priority to German patent application 10233441.2, filed Jul. 23, 2002, the both of which are herein incorporated by reference.

### BACKGROUND OF THE INVENTION

The invention relates to a plug guide for connecting a plug on a first circuit board to a mating connector or a plug receiving element on a second circuit board.

Such a connection of two circuit board connectors is necessary, for example, in the case of a digital tachograph where the circuit board for the display must be connected to the system circuit board of the tachograph.

Since, as a rule, the plug is provided on the rear of the display circuit board and the system circuit board is accommodated in a housing, the plug in process cannot be visually checked. The circuit board plug connections used are in most cases plugs or connector strips or plug receiving elements with a large number of pins. It must, therefore, be ensured that the plug is not plugged in offset by one or more plug in positions, resulting in wrong electrical polarization. This is of the greatest significance particularly in the case of plug connections with a large number of pins since misplugging with an offset by one row of pins upwards, downward or to the side is practically unrecognizable visually from the outside and must be corrected again with effort only when the entire device is electrically connected.

### SUMMARY OF THE INVENTION

The invention is, therefore, based on the object of providing a plug guide for the abovementioned purpose, which always ensures a correct plug in process.

The object is achieved by the fact that the plug guide surrounds the plug at least in a u-shaped manner and can be secured in relation to the plug.

The fact that the plug is surrounded by the plug guide in at least a u-shaped manner establishes a type of coding with respect to the mating connector so that any offset to the side or to the top or bottom is impossible.

Securing the plug guide relative to the connector prevents loss so that, during the plugin process, the plug guide is not lost accidentally and unnoticed and misplugging occurs.

The plug guide according to the invention thus makes it possible to ensure a correct plugging process even without a visual check.

In the plug guide according to the invention, the guiding is advantageously achieved by the external geometry and also by the internal geometry. The inside geometry of the plug guide matches the mating connector in such a manner that it can be plugged into the plug guide with only very little play. To make the plugging process as simple as possible, the inside geometry is preferably provided with generous lead-in bevels or chamfers at the edges at the plugin end.

To provide for easy plugging-in also with respect to the guide achieved by the outside geometry, the top and bottom edge at the plugging end is preferably also provided with generous lead-in bevels.

According to a preferred embodiment, the plug guide is bindingly connected to the plug or to the circuit board of the plug, respectively.

An embodiment provides that, for this purpose, vertical metal strips stand away from the circuit board, into which the plug guide is pushed on with an L-shaped hook arranged at the top. A further development provides that, at the top of the plug guide, noses are molded on which can lock into corresponding recesses on further metal lugs standing away vertically. As a rule, the metal strips are present in any case since they are used for securing the display on the circuit board.

Thus, the cross-sectionally u-shaped plug guide can be
a) pushed over the plug, on the one hand,
b) jammed between the metal strip standing away vertically from the circuit board, and the plug,
c) jammed with a metal strip via the L-shaped hook on the top, and
d) locked on both sides via noses molded on at the top of the plug guide to corresponding recesses in the metal strips.

The position of the plug guide is thus unambiguously established so that the risk of mispluggings during the plugging process is eliminated.

According to a preferred embodiment, the metal lugs standing away from the display circuit board have through holes which are aligned with further through holes in the plug guide and are used for screwing the display circuit board to the plug guide, the system circuit board and possibly a housing surrounding the system circuit board.

The screwing together has the advantage that, when a force is acting on the display circuit board, the forces are not absorbed via the plug connection but via the screw connection. A transmission of force via the plug connection would have the disadvantage that the contacts become fatigued with time and thus a high endurance strength of the plug connection would not be guaranteed.

Further advantages of the invention are specified in the subclaims and in the subsequent description of the figures.

### BRIEF DESCRIPTION OF THE SEVERAL VIEWS OF THE DRAWINGS

The invention will now be explained in greater detail with reference to an exemplary embodiment shown in the drawings, in which:

FIG. 1 shows an oblique view of a display circuit board with plug and plug guide plugged on,

FIG. 2 shows the display circuit board according to FIG. 1 in an alternative oblique view,

FIG. 3 shows detail Z from FIG. 2,

FIG. 4 shows a section through a housing of a tachograph with system circuit board (section Z-Z, see FIG. 5),

FIG. 5 shows section A-A from FIG. 4,

FIG. 6 shows the plug guide in a view from the bottom,

FIG. 7 shows the plug guide in a front view,

FIG. 8 shows the plug guide in a side view,

FIG. 9 shows section A-A from FIG. 7,

FIG. 10 shows section B-B from FIG. 7, and

FIG. 11 shows the plug guide in a view from the top.

### DETAILED DESCRIPTION OF THE INVENTION

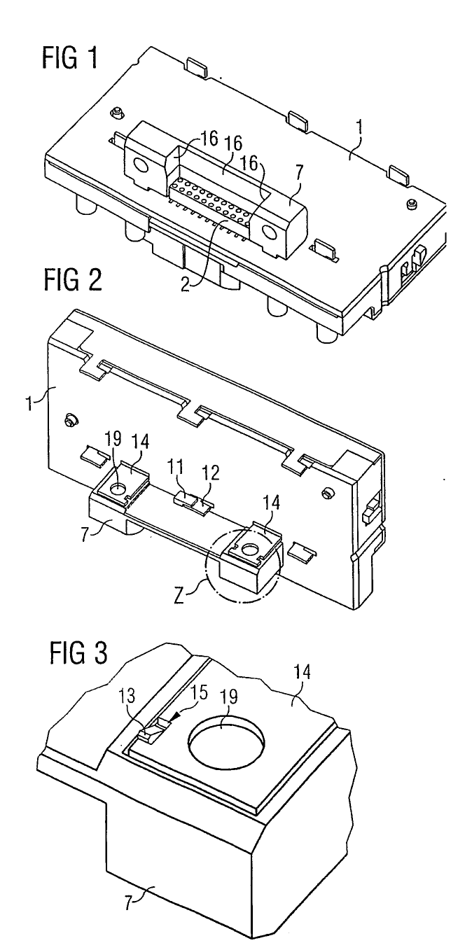

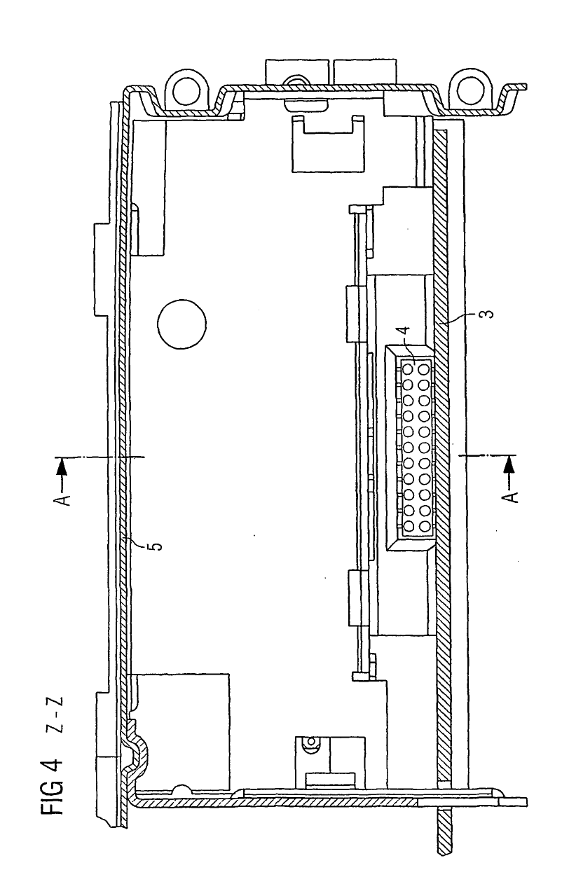

FIG. 1 shows a circuit board 1 for a display of a digital tachograph (DTCO). At the rear of the circuit board 1, a plug 2 with a multiplicity of pins is provided which is used for contacting the circuit board 1 with a system circuit board 3 (see FIG. 4) of the digital tachograph.

On the system circuit board 4, a corresponding mating connector 4 is provided into which the plug 2 has to be plugged. The plug 2 is constructed as connector strip and the mating connector 4 is constructed as BLADE connector in the exemplary embodiment shown.

As can be seen from FIGS. 4 and 5, the system circuit board 3 is completely accommodated in a housing 5 which is also closed at the front or, respectively, at the plugging end, with a cover 6 (see FIG. 5).

Since, during the plug in process of the plug 2 on the display circuit board 1 into the mating connector 4 on the system circuit board 3, the plugging process cannot be checked visually and the risk of mispluggings is to be avoided, a u-shaped plug guide 7 is provided according to the invention at the plug 2, which surrounds the plug 2 on three sides in a closely adjoining manner with only little play and only exposes the plug 2 on the underside. The underside of the plug 2 must be exposed in order to provide the possibility of a plugging process for the mating connector 4 arranged horizontally on the system circuit board.

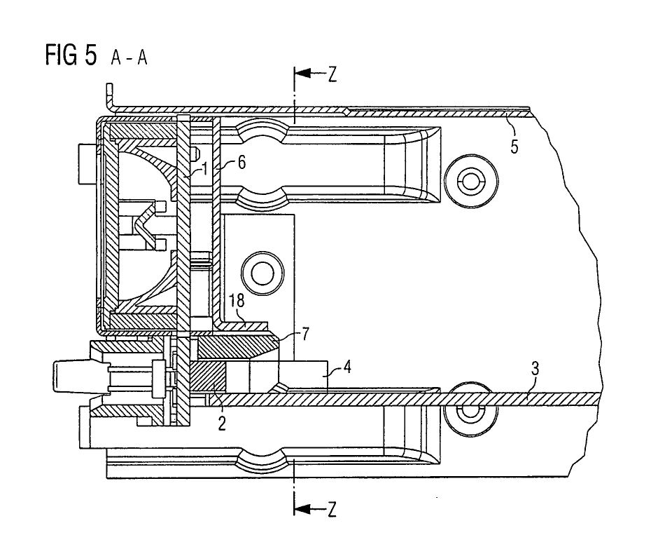

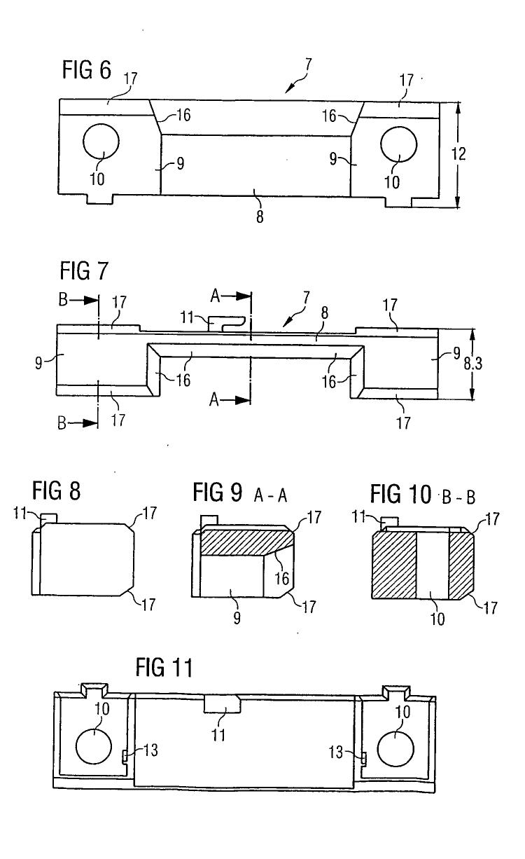

The plug guide 7 is shown in detail in FIGS. 6 to 11 and will be explained in greater detail with reference to these figures.

FIG. 6 shows the plug guide 7 in a view from the bottom. The plug guide comprises a center part 8 and two lateral flanges 9. In the lateral flanges 9, through holes 10 are provided which allow the plug guide to be screwed down.

FIG. 7 shows the plug guide 7 in a view from the front. The plug guide has above the center part 8 an L-shaped hook 11 which is used for securing the plug guide 7 to the display circuit board 1. On the display circuit board 1, for this purpose, a lug 12, which is enclosed by the hook 7 during the plugging on, stands away essentially vertically toward the outside.

Further securing of the guide part 7 on the display circuit board 1 is achieved by the fact that noses 13 are provided above the flanges 9 on the plug guide 7 and so that further metal lugs 14 stand away from the circuit board 1 which have corresponding recesses 15 which, in turn, can be engaged by the noses 13.

The noses 13 are formed in a wedge shape so that, after the noses 13 have become locked in the recesses 15, the plug guide can no longer be pulled from the circuit board 1 without detaching the locking.

Lateral securing is similarly achieved by the two oppositely located noses 13 at recesses 15 and by the hook 11. Further centering of the plug guide 7 with respect to the plug 2 is achieved by the cross-sectionally u-shaped internal geometry of the plug guide 7 which prevents lateral movement and, respectively, movement toward the plug.

As already explained at the beginning of the description of the figures, FIG. 4 shows the system circuit board 3 with the mating connector 4 which is completely surrounded by a housing 5. On the plug in side, the housing 5 is closed with a cover 6 which only exposes the access to the mating connector 4 through an opening. To now facilitate the plugging process of the plug 2 with plugged-on plug guide 7 into the mating connector 4 as shown in FIG. 5, the plug guide is provided in each case with a lead-in bevel 16 both at the lateral edges of the internal geometry at the plug in end and at the upper edge of the internal geometry at the plug in end.

The lead-in bevels 16 are shown in an enlarged representation in FIGS. 6, 7 and FIG. 9.

The lead-in bevels 16 ensure that, even if the plug 2 is introduced slightly from the side, it is precisely guided over the mating connector 4.

So that the plug in process is facilitated also due to the external geometry of the plug guide 7, it is also provided with a chamfer or lead-in bevel 17 both on the lower edge at the plug in end and on the upper edge at the plug in end. As seen in FIG. 5, the lower lead-in bevel 17 facilitates the movement of introduction with respect to the system circuit board 3 and the upper lead-in bevel 17 the movement of introduction with respect to the cover 6 which closes the housing 5 of the digital tachometer at the front before the display circuit board with the display is attached.

As shown in FIGS. 6 to 11, the plug guide 7 is represented as being made of one piece of plastic and only needs to be plugged onto the plug 3 on the system circuit board 1, during which process, due to the hook 11 attached on the top and the noses 13 standing away on the top (see FIG. 11), a locking to the metal lugs 14 standing away toward the rear on the display circuit board 1 and to the recesses 15 in the metal lugs 14, respectively, takes place.

FIG. 8 shows the plug guide 7 in a side view, and the lead-in bevels 17 can be seen here on the upper and lower edge at the plug in end.

FIG. 9, which shows section A-A on the center part of the plug guide 7, additionally shows the lead-in bevel 16 at the upper inside of the center part.

In FIG. 10, which shows section B-B from FIG. 7, the through hole 10 for connecting the plug guide 7 to the system circuit board 3, the metal lugs 14 of the display circuit board and the cover 6 of the housing can be seen.

As is shown in FIG. 2, the metal lugs 14 standing away from the display circuit board 1 are also provided with a through hole 19 for this purpose, which are aligned with the through holes 10 of the plug guide when the plug guide 7 is plugged on.

As a result, in the mounted state (see FIG. 5) the plug guide together with the metal lugs 14 can be screwed to the system circuit board 3 and also to the cover 6, which is angled away toward the inside on the underside, or, respectively, the threaded hole 18 provided in it.

Due to the system circuit board being screwed to the plug guide 7, the cover 6 and the metal lugs 14, scarcely any or almost no force is transferred to the electrical plug connection even when the display is touched.

The invention is not restricted to the exemplary embodiment shown. It is not mandatory that the two circuit boards 1 and 3 are perpendicular to one another during the plugging process and, respectively, the plug guide does not mandatorily need to be constructed to be unshaped but can also be closed all around.

1. A plug guide for connecting a plug on a first circuit board and a mating connector or a plug receiving element on a second circuit board, the first circuit board being arranged perpendicularly to the second circuit board in the plugged in state and the plug guide being securable in relation to the plug, comprising:
a body formed so as to surround the plug in a u-shaped manner, such a way that an underside of the plug is exposed in order to provide for a plugin process with the mating connector on the second circuit board and, in the plugged in state, the free ends of the u-shaped plug guide point in a direction of a side of the second circuit board on which the mating connector is arranged.

2. The plug guide according to claim 1, wherein guiding of the plug guide is achieved by external geometry and/or internal geometry of the plug guide.

3. The plug guide according to claim 2, wherein the internal geometry matches the mating connector in such a manner that the mating connector can be plugged into the plug guide with little play.

4. The plug guide according to claim 2, wherein the internal geometry includes lead-in bevels arranged at edges at a plug in end.

5. The plug guide according to claim 2, wherein the external geometry includes partial lead-in bevels at edges of a plug in end.

6. The plug guide according to claim 1, wherein the plug guide is bindingly secured on the first circuit board.

7. The plug guide according to claim 6, wherein, for the binding securing, an L-shaped hook is provided on top of the plug guide and a lug standing away vertically for inserting the hook is provided on the circuit board.

8. The plug guide according to claim 6, wherein the plug guide further comprises noses arranged on top and metal lugs with corresponding recesses arranged standing away vertically from the circuit board and which in recesses of the noses become locked in a mounted state.

9. The plug guide according to claim 1, wherein the plug guide further comprises through holes arranged on both sides for screwing together the second circuit board and a housing, surrounding the second circuit board, or a cover.

10. The plug guide according to claim 1, wherein the first circuit board is a display circuit board of a digital tachograph and the second circuit board is a system circuit board in a housing of the digital tachograph.
